(19) United States
(12) Patent Application Publication
(10) Pub. No.: US 2019/0308378 A1
(43) Pub. Date: Oct. 10, 2019

(54) Method of Designing and Producing Carbon Fiber Bellhousings

(71) Applicant: Bryan Gill, Rancho Palos Verdes, CA (US)

(72) Inventor: Bryan Gill, Rancho Palos Verdes, CA (US)

(21) Appl. No.: 16/356,961

(22) Filed: Mar. 18, 2019

Related U.S. Application Data
(60) Provisional application No. 62/644,515, filed on Mar. 18, 2018.

(51) Int. Cl. B29C 70/44; B29C 33/38; B29C 70/54

(52) U.S. Cl. CPC B29C 70/443; B29K 2307/04; B29C 70/545; B29C 33/38

(57) ABSTRACT

A method of designing and producing bellhousings using Carbon Fiber reinforced hybrid vinyl ester molding compound pre-impregnated woven cloths of carbon fiber composite fiber, each layer being about 0.060 thousand thick, requiring approximately 4-5 sheets of carbon material necessary to make a desired thickness of 0.0250 thick after compression molded into shape. Then once released from compression mold we then machine the critical dimensions such as, the edges to remove the flash from the molding, opening of the transmission hole in the center, and drill dowel and mounting holes which allow the bellhousing to be bolted to the rear of the specific engine type of one several different applications or designs on the flange of the bellhousing. This area can integrate a multiple of different bolt designs for various type engines, i.e. Ford, GM, Chrysler etc., while being located on a common locating dowel.

### RELATED APPLICATION

This application claims the benefit of U.S. provisional applications 62/644,515 filed Mar. 18, 2018, in the U.S. Patent and Trademark Office, titled “Carbon fiber bellhousing” of inventor Bryan Gill, which is hereby incorporated herein by reference in its entirety.

### BACKGROUND AND FIELD OF THE INVENTION

The present invention relates to automotive type bellhousings manufacturing and methods of designing and producing composite bellhousings. More specifically, the present invention pertains to an entirely new method of designing and producing a bellhousing using compression molded, pre-impregnated fiber composite material that is formed onto a dye or mold, then is drilled and machined to fit various transmissions and various bolt pattern(s) of a multiple of engines, i.e. Ford, GM, Chrysler etc. The bellhousing is then finished machined for abatement of rough edges, multiple of applications, transmission types, mounting bolt holes, clutch openings. The purpose of this invention is to produce a unit which is significantly lighter (at 1.4 Gm/cc vs aluminum at 2.7 Gm/cc, titanium at 4.5 Gm/cc and steel at 7.5 Gm/cc after being formed), along with a design process that allows several different designs to be machined from a shaped mold of composite material.

Automotive bellhousings are canister type housings shaped like the rear of the engine and located between the engine and transmission. (See FIG. 1)

Bell housing or bellhousing is a colloquial/slang term for the portion of the transmission that covers the flywheel and the clutch or torque converter of the transmission on vehicles powered by internal combustion engines. This housing is bolted to the engine block and derives its name from the bell-like shape that its internal components necessitate. The starter motor is usually mounted here (FIG. 1, H) and engages with a ring gear on the flywheel. On the opposite end to the engine is usually bolted to the engine block. The use of different bellhousings on a transmission allows the same transmission to be used on multiple engines in multiple applications, i.e. Ford, Chrysler and GM etc. Typically, these devices are made of some type of metal, i.e., steel, aluminum and in rare cases even titanium. The starter in most cases attaches to engine block which protrudes into the outer edge of the bellhousing while the drive gear engages the ring gear, turning the flywheel, which rotates the crankshaft, imparting the initial starting motion to the engine. High performance bellhousings are lightweight and high strength structures that can be specifically designed to reduce mass sufficiently durable for competition or rigorous use. High performance and exotic engines are not the only engines in which may benefit from this technology. Bellhousings can be replaced for increased performance or in addition to better economy. The present invention is directed to a new method of manufacturing and designing high performance bellhousings, which aims to increase performance thereof while maintaining a high degree increased economy.

The present invention relates to a new method of designing and producing a current design in a composite bellhousing(s), that do for the most part require specific molds or different sizes for each induvial application(s), those which differ can be formed into a shape using a specific mold or dye then compression molded by the technique. The resulting product is directional and conforms to the shape of the mold or dye, wherein fibers are supported within a matrix in random directions to produce an overall quasi-isotropic material system. Using this material, the bellhousing design process benefits and can utilize the fact that this material system is machinable after being formed. Further provided is an efficient design method that utilizes Carbon Fiber reinforced hybrid vinyl ester molding compound woven cloth carbon fiber composite material system to create a bellhousings blank that is adaptable by compression molding into different diameters while minimizing lost materials during the machining process. Once the bellhousings design is machined, drilled in the bolt areas and inserts placed in the bolt holes which mount the bellhousings to the back of the crank.

The present invention comprises a new design and manufacturing method of replacement of existing design metal bellhousings with, composite bellhousings using Carbon Fiber reinforced hybrid vinyl ester molding compound woven cloth carbon fiber composite fiber material, wherein the design reduces material waste, reduces engineering design expense for each bellhousings design, and reduces the cost of composite bellhousings to end users or consumers. Various molds are used to accommodate a plurality of bellhousings designs, sizes, diameters, and shapes, whereby the resulting bellhousings blank from a mold process is finished machined to a specific size and shape for the desired bellhousings. The resulting bellhousings is then connected to the rear of the engine block between the engine and transmission to produce a high-performance assembly for containment at a reduced cost and weight compared to traditional methods of metal bellhousings in the market.

It is submitted that the present invention substantially diverges in design elements and method steps from the prior art of metal, and consequently it is clear that there is a need in the art for an improvement to existing fully metal bellhousings designs and manufacturing methods. In this regards the instant invention substantially fulfills these needs. The carbon fiber bellhousing is made to meet or exceed the containment requirements for industry acceptable safety standards as compared to its contemporary incumbent counterparts in metal.

### SUMMARY OF THE INVENTION

In the view of the foregoing disadvantages inherent in the known types of fully metal bellhousings and design and manufacturing methods present in the art, the present invention provides a new design and manufacturing method wherein the same can be utilized for producing a high strength composite bellhousing that reduces cost and wasted material to produce a lightweight, high performance bellhousing for competition or performance road use, which meet or exceeds industry standards for containment.

It is therefore an objective of the present invention to provide a new method of designing and manufacturing bellhousings previously made in metal, either aluminum, steel or titanium, wherein the method includes a process of forming Carbon Fiber reinforced hybrid vinyl ester molding compound woven cloth carbon fiber composite fiber material, compression molded into a bellhousings blank that is machinable to the end design of the given bellhousing(s) specific to the application desired.

Another objective of the present invention is to provide a design method for creating a composite bellhousing in which one mold can be utilized to create a bellhousing blank that accommodates a plurality of different bellhousings designs, whereby the final design is finished machined from the singly designed blank. Another objective of the present invention is to provide design method of composite bellhousing that aims to decrease weight and increase strength and efficiency to the end consumer, while still retaining the primary advantages associated with composite bellhousing (light weight, high stiffness, high strength, greater fatigue life, etc.).

Other objectives, features and advantages of the present invention will become apparent from the following detailed description taken in conjunction with the accompanying photos.

### BRIEF DESCRIPTION OF THE DRAWINGS

FIG. 1 shows a perspective view, partially schematic of a steel bellhousing;

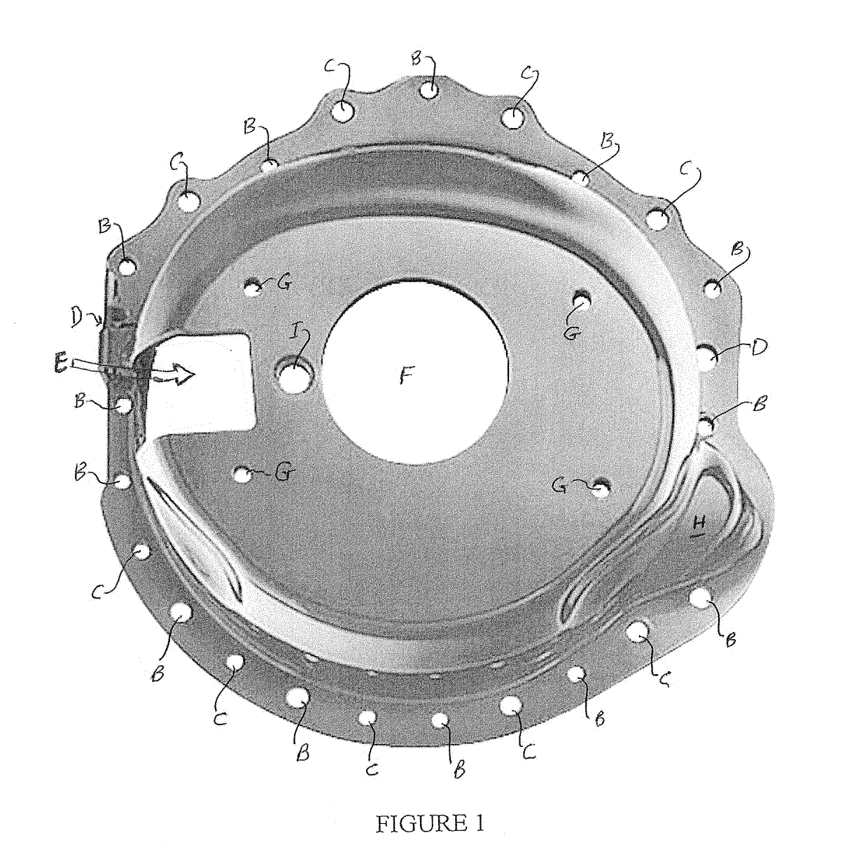

FIG. 2 shows a perspective view of an aluminum bellhousing; and

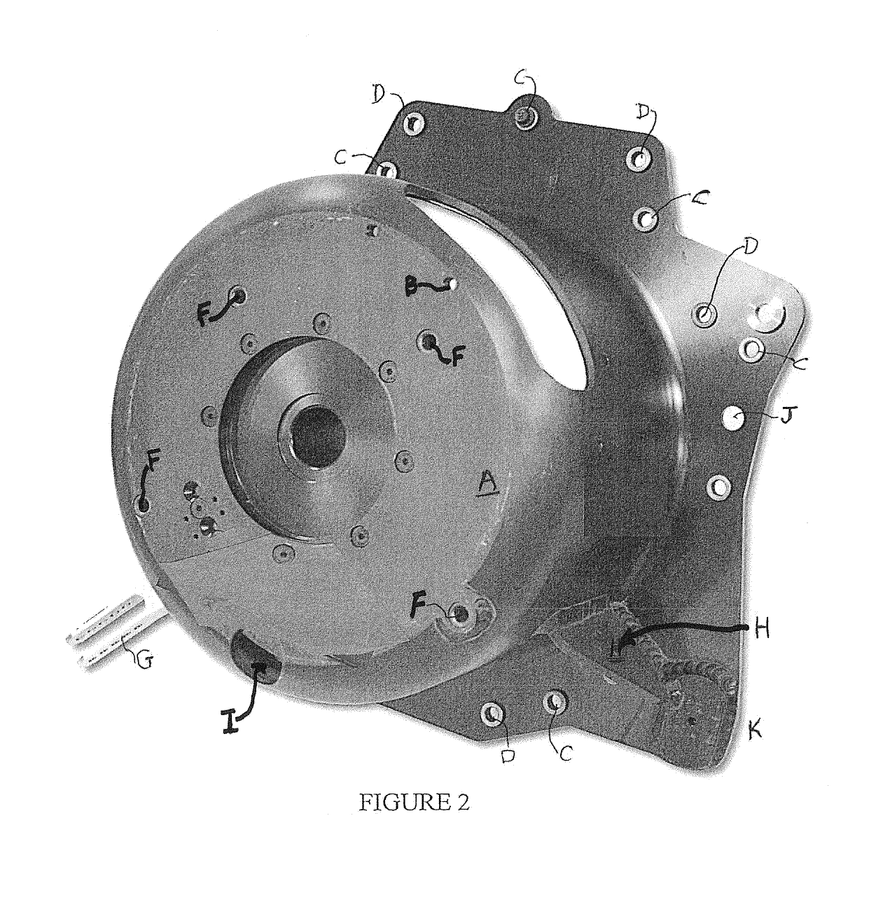

FIG. 3 shows a carbon fiber composite and connections in accordance to the present invention including inspection shield.

### DETAILED DESCRIPTION OF THE INVENTION

Reference is made herein to the attached FIGURES. Like reference arrows are used throughout the figures to depict like or similar elements of the present method. For the purposes of presenting a brief and clear description of the present invention, the preferred embodiment will be discussed as used for creating a composite bellhousing blank section using Carbon Fiber reinforced hybrid vinyl ester molding compound woven cloth carbon fiber composite fiber material, and a design process that minimizes waste and costs. The arrows are intended for representative purposes only and should not be limiting in any respect.

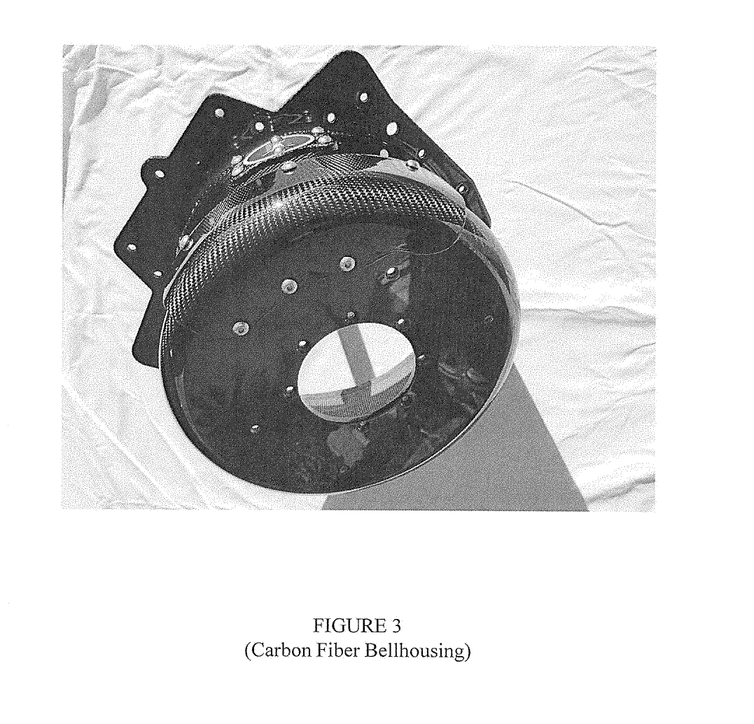

FIG. 3 is representative of the new design method and method of manufacturing for bellhousing using Carbon Fiber reinforced hybrid vinyl ester molding compound composite material, wherein the production of the bellhousing involves a compression molded forming process and the design method allows for multiple different bellhousing designs to be incorporated into a single manufacturing process. The design method reduces material waste and costs of the bellhousing for the end consumer, while maintaining the benefits offered by composite bellhousings. Specifically, Carbon Fiber reinforced hybrid vinyl ester molding compound woven cloth carbon fiber composite fiber is used to create the bellhousing, wherein the Carbon Fiber reinforced hybrid vinyl ester molding compound woven cloth carbon fiber composite fiber is placed into a mold, compression molded into a formed shape, and then finished machined into a final application specific bellhousing design. The use of Carbon Fiber reinforced hybrid vinyl ester molding compound woven cloth carbon fiber composite and a forming process allows designers and fabricators to finish machine the final design from a larger bellhousing blank, which allows one bellhousing blank to be utilized for multiple bellhousing design to accommodate any number of applications without necessarily individually engineering each bellhousing and creating a specific mold for each bellhousing design. This eliminates the traditional full metal forging or formed process, which is labor intensive and design intensive, and requires a specific tooling or mandrel or mold for each bellhousing design.

The present invention contemplates creating a composite bellhousings blank of Carbon Fiber reinforced hybrid vinyl ester molding compound woven cloth carbon fiber composite fiber, but rather than forging strictly metal, the present invention method utilizes a Carbon Fiber reinforced hybrid vinyl ester molding compound woven cloth carbon fiber composite molding process and a design process similar to metallic bellhousing fabrication but with improved strength to weight ratio efficiency and with greater weight optimization. Since Carbon Fiber reinforced hybrid vinyl ester molding compound woven cloth carbon fiber composite fiber is more expensive than metallic materials, a shaped bellhousings blank is created from the combination of several different bellhousing's designs, which can then be finished machined down to the exact bellhousing design or application specific to or chosen by the end user. Bellhousing construction is comprised of multiple layers of carbon materials onto one another in a design mold to establish the shape of the bellhousings blank to be created from the Carbon Fiber reinforced hybrid vinyl ester molding compound woven cloth carbon fiber composite fiber material in a mold. Each layer of the carbon fiber material is approximately 0.060 thick, it requires about 4-5 sheets of Carbon Fiber reinforced hybrid vinyl ester molding compound woven cloth carbon fiber composite fiber compression molded to 0.250 thick. The process can accommodate bellhousings of different diameter and design, wherein the final product is connected to an engine.

A method of designing and producing bellhousings using Carbon Fiber reinforced hybrid vinyl ester molding compound pre-impregnated woven cloths of carbon fiber composite fiber, each layer being about 0.060 thousand thick, requiring approximately 4-5 sheets of carbon material necessary to make a desired thickness of 0.0250 thick after compression molded into shape. Then once released from compression mold we then machine the critical dimensions such as, the edges to remove the flash from the molding, opening of the transmission hole in the center, and drill dowel and mounting holes which allow the bellhousing to be bolted to the rear of the specific engine type of one several different applications or designs on the flange of the bellhousing. This area can integrate a multiple of different bolt designs for various type engines, i.e. Ford, GM, Chrysler etc., while being located on a common locating dowel. Compression molding uses various layers of Carbon Fiber reinforced hybrid vinyl ester molding compound pre-impregnated woven cloth carbon fiber composite fiber sheets having a starting thickness of 0.060 per sheet, with approximately 4-5 sheets of triaxial woven sheets of carbon fiber in conjunction with sheets of carbon fiber reinforced hybrid vinyl ester molding compound compressed into a form or mold to a uniform thickness of 0.0250. This combination of laminate material has a mechanical property of (as molded) tensile strength of 61,000 (421), unit of psi=(MPa) sheet molding compound (SMC), bulk molding compound (BMC). This combination of carbon fiber in compression molded thermoset process produces a greater strength-to-weight ratio compared to existing steel and aluminum parts. The bellhousings would be compression molded or shaped on a basic form or tooling die made specifically for the subject bellhousing to produce the desired shape, and then finish machined all unfinished surfaces i.e. edge and holes for mounting and transmission, vent tubes if necessary, and clutch arm opening(s). Meaning that the newly molded bellhousing is placed into a mill, then the circumference area finished machined, the bolt holes which locate the bellhousing to the engine assembly are drilled into place, transmission hole/opening is milled into the desired size(s), and the vent and clutch opening is machined into place. After the specific machining is performed, the bolt holes, locating dowel holes and any possible vent tubes and inspection covers are drilled, and we then finish machining all unfinished or rough surfaces. Bellhousings are then sealed with sodium silicate or ceramic material to mitigate hydroscopic condition(s). We may elect to use a titanium liner or any other type metal “burst shield” as an additional containment component inside the bellhousing.

Once released from the mold, the Carbon Fiber reinforced hybrid vinyl ester molding compound woven cloth carbon fiber composite fiber Bellhousings blank is finished machined into a final design. A CNC milling machine or similar device is utilized to machine the larger bellhousing blank into the final bellhousing design. It is submitted that the instant invention has been shown and described in what is the most practical and preferred method steps. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function, steps, and manner of operation, assembly and use, are deemed clear and obvious to one skilled in the art, and all equivalent relationships to those illustrated in the photos and described in the specification are intended to be encompassed by the present invention as related to our design in carbon fiber material.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method of designing and producing a full composite bellhousing using a Carbon Fiber reinforced hybrid vinyl ester molding compound woven cloth carbon fiber composite-based composite material, comprising the steps of:
choosing one or a plurality of bellhousing designs;
overlaying said bellhousings designs to determine a single bellhousings blank design;
creating a reverse mold of said bellhousing blank design;
molding a bellhousings blank by applying compression; and thereafter
machining to complete said bellhousing blank into one of said bellhousings designs for use in a specific engine/drive assembly.

2. The method of claim 1, wherein said choosing said bellhousing designs further comprises the steps of:
determining diameter, depth, fork location, type of transmission, bolt or mounting pattern, design of said bellhousing designs prior to molding said bellhousing designs.

3. The method of claim 1, wherein compression or autoclave molding said bellhousing blank further comprises the steps of:
shaping composite material, setting of material(s) on a form or mold;
communicating said composite material and mold into a vacuum bag, placing into an autoclave, and removing said material after cooling; or
removing the blank from the mold, then applying final machine process to bring into compliance for final usage by consumer.
